(19) United States
(12) Patent Application Publication
(10) Pub. No.: US 2005/0094995 A1
(43) Pub. Date: May 5, 2005

(54) Dial structure

(75) Inventor: Li Chieh Cheng, Taipei (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 10/972,504

(22) Filed: Oct. 25, 2004

(30) Foreign Application Priority Data
Oct. 30, 2003 (TW) TW92219268

(51) Int. Cl. G03B 17/00

(52) U.S. Cl. 396/543

(57) ABSTRACT

A dial structure. The dial structure includes a dial and a fixing member. The dial has a fixed surface, with an engaging element and a protrusion formed thereon. The fixing member is rotatably disposed on the fixed surface and has a first through hole and a resilient arm. The engaging element of the dial penetrates the first through hole and engages the fixing member, and the resilient arm extends into the first through hole and is retarded by the protrusion of the fixed surface.

### BACKGROUND OF THE INVENTION

1. Field of the Invention

The present invention relates to a dial structure, and in particular to a dial structure that is easily assembled and provides better resistant strength against pulling.

2. Description of the Related Art

A digital camera usually has a dial structure for functional selection and operation. A conventional dial is fixed on the digital camera by means of a hook thereof engaging the housing of the digital camera, or bolts.

First, since the inner space of the digital camera is usually small, the hook of the conventional dial cannot extend to become flexible. Namely, the hook is stiff when the length thereof is limited. When the conventional dial is fitted into a hole on the housing of the digital camera to engage the housing thereof, the hook thereof is easily broken. In addition, when the hook of the conventional dial is small, it can be easily fit into the hole on the housing of the digital camera. The small hook, however, cannot provide sufficient resistant strength against pulling.

Further, when the dial is fixed on the digital camera by bolts, the dial can provide better resistant strength against pulling. Nevertheless, mounting the bolts with tools such as screwdrivers is difficult due to the limited inner space of the digital camera.

Hence, there is a need to provide an improved dial structure. Namely, the present dial structure provides sufficient resistant strength against pulling, such that it is better protected against being pulled out of the housing of the digital camera. Also, the present dial structure can be easily assembled on the housing of the digital camera.

### SUMMARY OF THE INVENTION

Accordingly, an object of the invention is to provide a dial structure comprising a dial and a fixing member. The dial has a fixed surface, with an engaging element and a protrusion formed thereon. The fixing member is rotatably disposed on the fixed surface and has a first through hole and resilient arm. The engaging element of the dial penetrates the first through hole and engages the fixing member, and the resilient arm extends into the first through hole and is retarded by the protrusion of the fixed surface.

The protrusion further comprises a slanted surface and a retardant surface perpendicular thereto. The slanted surface extends to the retardant surface from the fixed surface. The resilient arm of the fixing member slides on the slanted surface and is retarded by the retardant surface. The resilient arm further comprises a retardant portion retarded by the retardant surface. The retardant surface is a curved surface.

The fixing member further comprises a handle protruding therefrom.

The dial structure further comprises an intermediate member disposed between the dial and the fixing member and having a second through hole. The fixed surface of the dial is in the second through hole, and the engaging element protrudes intermediate member therefrom.

The intermediate member further comprises a toothed ring between the dial and the intermediate member.

The dial structure further comprises a clamping member slidably disposed on the toothed ring.

The toothed ring further comprises a plurality of toothed portions continuously and regularly formed thereon. The clamping member further comprises two clamping portions slidably disposed on opposite toothed portions of the toothed ring. The clamping member is a torsion spring.

The fixing member is composed of metal or stainless steel.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a partial perspective assembly view showing the dial structure of the invention prior to completed assembly;

FIG. 2 is a partial perspective exploded view showing the dial structure of the invention;

FIG. 3A is a perspective view showing the dial of the dial structure of the invention;

FIG. 3B is a side view showing the dial of the dial structure of the invention;

FIG. 4 is a perspective view showing the intermediate member of the dial structure of the invention;

FIG. 5 is a perspective assembly view showing the dial structure of the invention; and

FIG. 6 is a partial perspective assembly view showing the dial structure of the invention after assembly is completed.

### DETAILED DESCRIPTION OF THE INVENTION

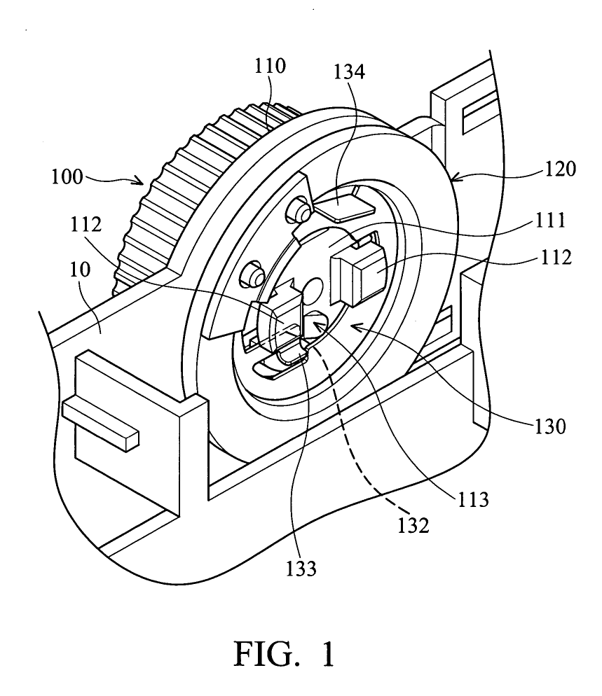

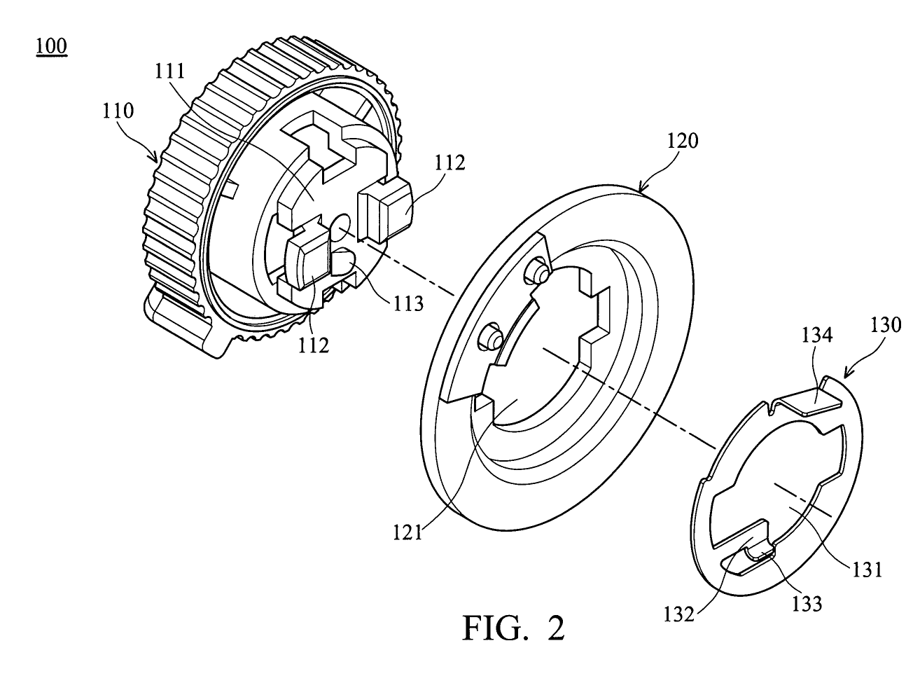

Referring to FIG. 1 and FIG. 2, the dial structure 100 is assembled on the housing 10 of a digital camera and comprises a dial 110, an intermediate member 120 and a fixing member 130.

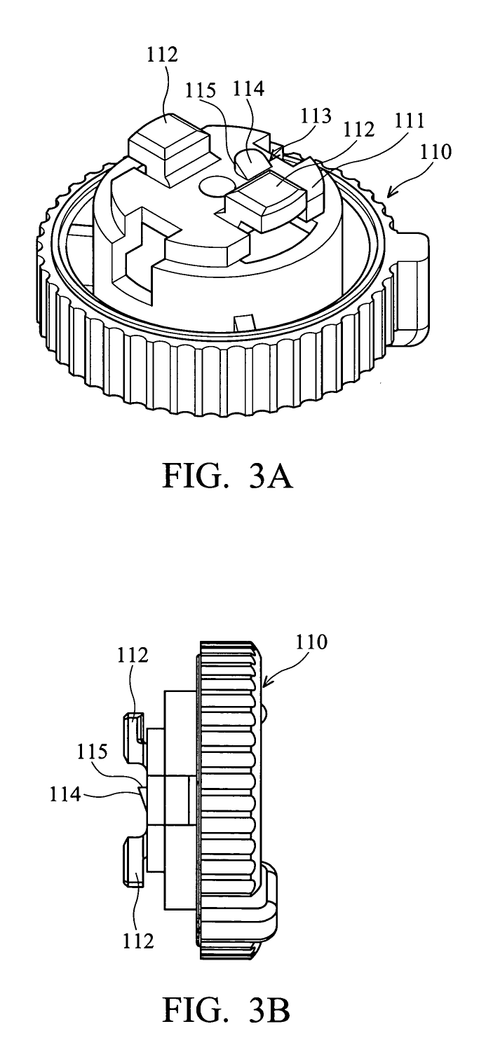

As shown in FIG. 2, the dial 110 has a fixed surface 111, with two engaging elements 112 and a protrusion 113 formed thereon. As shown in FIG. 3A and FIG. 3B, the protrusion 113 is composed of a slanted surface 114 and a retardant surface 115. Specifically, the retardant surface 115 is a curved surface and perpendicular to the slanted surface 114. The slanted surface 114 extends to the retardant surface 115 from the fixed surface 111 of the dial 110. The dial 110 is fit into a fitting hole (not shown) of the housing 10 of the digital camera. The fixed surface 111 of the dial 110 penetrates the fitting hole and protrudes from the housing 10.

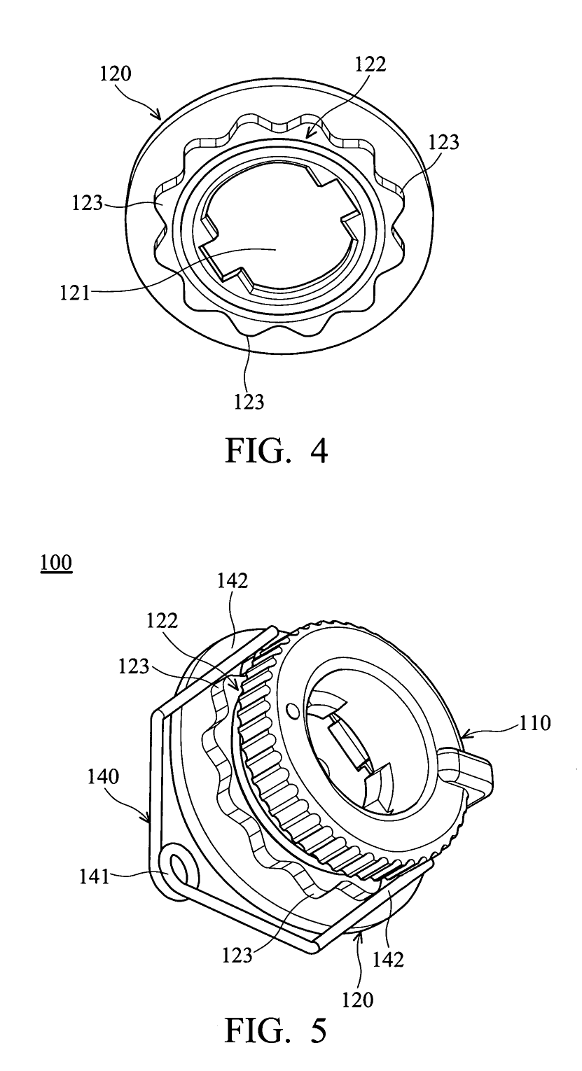

As shown in FIG. 1 and FIG. 2, the intermediate member 120 is disposed on the dial 110 and housing 10 and has a second through hole 121. The fixed surface 111 of the dial 110 is in the second through hole 121, and the engaging elements 112 protrude the intermediate member 120 therefrom. As shown in FIG. 4, a toothed ring 122 is formed on the intermediate member 120 and is composed of a plurality of toothed portions 123 continuously and regularly formed thereon. As shown in FIG. 1, when the intermediate member 120 is disposed on the dial 110 and housing 10, the toothed ring 122 is between the housing 10 (dial 110) and the intermediate member 120.

As shown in FIG. 1 and FIG. 2, the fixing member 130 is rotatably disposed on the intermediate member 120 and has a first through hole 131 and a resilient arm 132. Specifically, the engaging elements 112 of the dial 110 penetrate the first through hole 131 and are on the fixing member 130. The resilient arm 132 extends into the first through hole 131. Additionally, the resilient arm 132 has a retardant portion 133, and the fixing member 130 has a handle 134 protruding therefrom. The fixing member 130 is composed of metal or stainless steel to provide better strength.

Moreover, as shown in FIG. 5, the dial structure 100 has a clamping member 140 (not shown in FIG. 1). The housing 10 is omitted from FIG. 5 for clarity of the following description. The clamping member 140 may be a torsion spring and is fixed on the housing 10 by means of an annular portion 141 thereof. Additionally, the clamping member 140 has two clamping portions 142 slidably disposed on opposite toothed portions 123 of the toothed ring 122. Specifically, the clamping portions 142 simultaneously push against and slide on the opposite toothed portions 123. When the intermediate member 120 rotates, the clamping portions 142 are pushed outward by the top ends of the toothed portions 123 and retract to a position between two toothed portions 123 by means of the resilient force thereof. Thus, a positive interval response is generated when the intermediate member 120 rotates continuously.

The following description explains the assembly of the dial structure 100.

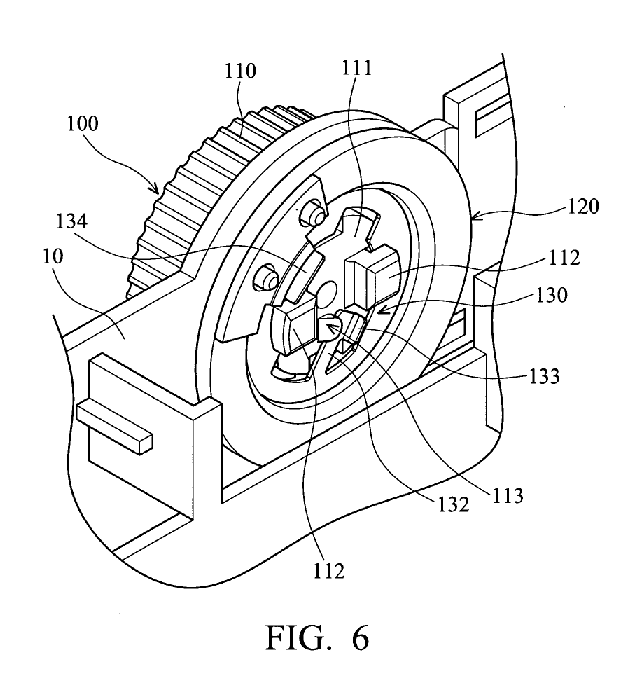

As shown in FIG. 1, the dial 110, intermediate member 120 and fixing member 130 are assembled together. The handle 134 of the fixing member 130 is turned counterclockwise to rotate the fixing member 130 by a predetermined angle (such as 60°). At this point, the resilient arm 132 of the fixing member 130 is slightly elastically deformed to slide on the slanted surface 114 of the protrusion 113. The resilient arm 132 then slides to the retardant surface 115 of the protrusion 113. At this point, the retardant portion 133 of the resilient arm 132 is retarded by the retardant surface 115, as shown in FIG. 6. Finally, the clamping member 140 is disposed on the intermediate member 120 as described above to complete the assembly of the dial structure 100.

Accordingly, since the dial 110, intermediate member 120 and fixing member 130 interfere with each other (the fixing member 130 is on the intermediate member 120 and the engaging elements 112 of the dial 110 engage the fixing member 130), the fixing member 130 provides fixing, push stop and return stop functions. Thus, when the dial 110 rotates, the intermediate member 120 and fixing member 130 rotate therewith and a positive interval response is generated. Additionally, since the resilient arm 132 of the fixing member 130 is retarded by the retardant surface 115 of the protrusion 113 and the fixing member 130 is composed of metal or stainless steel, the dial 110 can provide superior resistant strength against pulling.

The following description explains the disassembly of the dial structure 100.

As shown in FIG. 6, the clamping member 140 (not shown in FIG. 6) is removed from the housing 10 and intermediate member 120. A slotted screwdriver or similar tool is inserted between the retardant portion 133 and the fixed surface 111 to lift the resilient arm 132 to a position higher than the retardant surface 115. The handle 134 of the fixing member 130 is turned clockwise to rotate the fixing member 130 by the predetermined angle (such as 60°). The fixing member 130 can then rotate to a position as shown in FIG. 1 and be separated from the intermediate member 120. At this point, the dial 110, intermediate member 120 and fixing member 130 can be completely disassembled.

Specifically, the dial structure 100 of the invention can include merely the dial 110 and fixing member 130. The difference here is that the positive interval response is not generated turning the dial 110. Namely, the dial 110 and fixing member 130 can also be assembled on the housing 10 by adjusting the height or position of the fixed surface 111 of the dial 110. At this point, the dial 110 can still provide superior resistant strength against pulling.

Additionally, application of the dial structure 100 is not limited to a digital camera. Namely, the dial structure 100 can also be assembled on other electronic devices requiring a dial to perform functional selection and operation.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A dial structure, comprising:
a dial having a fixed surface, with an engaging element and a protrusion formed thereon; and
a fixing member rotatably disposed on the fixed surface and having a first through hole and a resilient arm, wherein the engaging element of the dial penetrates the first through hole and engages the fixing member, and the resilient arm extends into the first through hole and is retarded by the protrusion of the fixed surface.

2. The dial structure as claimed in claim 1, wherein the protrusion further comprises a slanted surface and a retardant surface perpendicular thereto, the slanted surface extending to the retardant surface from the fixed surface.

3. The dial structure as claimed in claim 2, wherein the resilient arm of the fixing member slides on the slanted surface and is retarded by the retardant surface.

4. The dial structure as claimed in claim 3, wherein the resilient arm further comprises a retardant portion retarded by the retardant surface.

5. The dial structure as claimed in claim 2, wherein the retardant surface is a curved surface.

6. The dial structure as claimed in claim 1, wherein the fixing member further comprises a handle protruding therefrom.

7. The dial structure as claimed in claim 1, further comprising an intermediate member disposed between the dial and the fixing member and having a second through hole, wherein the fixed surface of the dial is in the second through hole, and the engaging element protrudes the intermediate member therefrom.

8. The dial structure as claimed in claim 7, wherein the intermediate member further comprises a toothed ring between the dial and the intermediate member.

9. The dial structure as claimed in claim 8, further comprising a clamping member slidably disposed on the toothed ring.

10. The dial structure as claimed in claim 9, wherein the toothed ring further comprises a plurality of toothed portions continuously and regularly formed thereon, and the clamping member further comprises two clamping portions slidably disposed on opposite toothed portions of the toothed ring.

11. The dial structure as claimed in claim 9, wherein the clamping member is a torsion spring.

12. The dial structure as claimed in claim 1, wherein the fixing member is metal.

13. The dial structure as claimed in claim 1, wherein the fixing member is stainless steel.
